(19) United States
(12) Patent Application Publication
(10) Pub. No.: US 2016/0244593 A1
(43) Pub. Date: Aug. 25, 2016

(54) RESIN COMPOSITION, PREPARATION METHOD THEREOF AND OPTICAL FILM INCLUDING THE SAME

(71) Applicant: LG CHEM, LTD., Seoul (KR)

(72) Inventors: Jun-Geun UM, Daejeon (KR); Suk-Il YOUN, Daejeon (KR); Nam-Jeong LEE, Daejeon (KR); Sang-Min KWAK, Daejeon (KR); Sei-Jung PARK, Daejeon (KR)

(21) Appl. No.: 14/386,254

(22) PCT Filed: Jun. 17, 2014
(86) PCT No.: PCT/KR2014/005281

§ 371 Date: Sep. 18, 2014

(30) Foreign Application Priority Data
Jun. 18, 2013 (KR) 10-2013-0069835
Jun. 16, 2014 (KR) 10-2014-0072858

(51) Int. Cl. C08K 5/3492

(52) U.S. Cl. CPC C08K 5/3492

(57) ABSTRACT

There are provided a resin composition including a particulate thermoplastic acrylic resin and a triazine-based ultraviolet (UV) absorber, a preparation method thereof, and an optical film including the same.

### TECHNICAL FIELD

The present disclosure relates to a resin composition, a preparation method thereof, and an optical film including the same.

### BACKGROUND ART

In accordance with recent developments in the area of optical technology, various display technologies, such as plasma display panels (PDPs), liquid crystal displays (LCDs), organic electroluminescent (OEL) displays, light emitting diodes (LEDs), and the like, replacing existing cathode-ray tubes (CRTs), have been proposed and have come to the market. Meanwhile, various polymer films, such as polarizing films, polarizer protective films, retardation films, light guide plates, plastic boards, and the like, are being used in such display devices, and advances in the characteristics of polymer materials for display devices have significantly increased.

Meanwhile, protective films used in polarizing plates for LCDs may require a certain degree of ultraviolet (UV) absorption performance in order to prevent the deterioration of liquid crystals or polarizers caused by UV light. Therefore, technology for manufacturing a protective film having superior ultraviolet absorption performance by adding a UV absorber to a resin composition has been proposed.

As existing UV absorbers, benzotriazole-based compounds, benzophenone-based compounds, cyanoacrylate-based compounds, salicylic acid compounds, and the like are commonly used. By additionally using such UV absorbers in a process of manufacturing an optical film, deterioration resulting from exposure to UV light may be prevented. However, a majority of the UV absorbers may be decomposed during high temperature processing and the amount thereof may be decreased, whereby UV absorption performance may deteriorate and the resin and the film may be yellowed. In addition, a glass transition temperature of the raw material resin after adding the UV absorber to the resin composition may be significantly decreased as compared with a glass transition temperature of the raw material resin prior to adding the UV absorber thereto, resulting in reduced heat resistance. Furthermore, in a case of being exposed to UV light for an elongated period of time, the UV absorption performance of the optical film may deteriorate or the optical properties of the optical film itself may change.

In addition, at the time of forming the film, low compatibility of acrylic resin and UV absorber may cause a problem in separating the UV absorber from the resin composition to be discharged outwardly, whereby manufacturing equipment and the film may be contaminated.

Therefore, it is necessary to develop a resin composition for an optical film having superior UV absorption performance and a high glass transition temperature (Tg) while avoiding problematic discoloration and contamination.

### DISCLOSURE

### Technical Problem

An aspect of the present disclosure provides a resin composition having superior heat resistance properties and ultraviolet (UV) absorption performance, a preparation method thereof and an optical film including the same.

### Technical Solution

In order to solve the aforementioned problems, according to a first aspect of the present disclosure, there is provided a resin composition including a particulate thermoplastic acrylic resin and a triazine-based ultraviolet (UV) absorber.

According to a second aspect of the present disclosure, there is provided a method of preparing a resin composition including preparing a particulate thermoplastic acrylic resin and mixing the particulate acrylic resin with a triazine-based UV absorber, wherein the mixing process is performed by a mixer having a gear pump.

According to a third aspect of the present disclosure, there is provided an optical film manufactured by using resin pellets formed of the resin composition.

### Advantageous Effects

In the case of using the resin composition according to the first aspect of the present disclosure, an optical film may be manufactured to have superior ultraviolet (UV) absorption performance and heat resistance properties.

In addition, in the case of using the resin composition according to the second aspect of the present disclosure, uniformity in the size of resin pellets prepared using the same may be secured. By preventing a thickness deviation of an optical film to be manufactured, which may be caused by instability in the supply of the resin pellets in a melt extrusion process for forming the film, productivity may be enhanced and an impurity generation rate may be lowered, so that the optical film may be manufactured to have good exterior appearance.

### BEST MODE

Hereinafter, embodiments of the present disclosure will be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

As a result of repeated experimentation aimed at developing a resin composition for an optical film having superior ultraviolet (UV) absorption performance while having a good UV protection effect in addition to superior physical properties in terms of transparency, color tone, and heat resistance, the inventors of the present invention have invented a resin composition described herein.

That is, the resin composition according to exemplary embodiments of the present disclosure is obtained by preparing a thermoplastic acrylic resin in the form of particles rather than in the form of pellets and mixing the prepared resin with an additive having a certain degree of UV absorption performance, thereby solving the mixing problem occurring in mixing the acrylic resin pellets with the UV absorber. In particular, in the case in which the acrylic resin pellets are mixed with the UV absorber by using a twin screw extruder, miscibility may be low, and thus, the thermoplastic resin composition may not be dissolved due to the UV absorber, but be discharged outwardly. Accordingly, it has been difficult to mix 1 or more part by weight of the UV absorber with respect to 100 parts by weight of the acrylic resin. However, the resin composition according to the exemplary embodiments of the present disclosure includes approximately 5 parts by weight of the UV absorber with respect to 100 parts by weight of the acrylic resin. Even in the case that the content of the UV absorber in the resin composition is significantly high as compared with existing resin compositions according to the related art, the mixing thereof may be achieved by using the twin screw extruder after solid-solid mixing. Therefore, in the case in which an optical film is manufactured using the resin composition according to the exemplary embodiments of the present disclosure, the optical film may have superior UV absorption performance and heat resistance properties.

According to a first exemplary embodiment of the present disclosure, there is provided a resin composition including a particulate thermoplastic acrylic resin and a UV absorber.

In the exemplary embodiment of the present disclosure, the thermoplastic acrylic resin may be a particulate resin having an average particle diameter of 10 μm to 500 μm.

Here, the form of the thermoplastic acrylic resin is not particularly limited so long as the resin is provided in the particulate form. For example, particles of the thermoplastic acrylic resin may have the form of beads, dumbbells, ellipses, or the like. Preferably, the particles of the thermoplastic acrylic resin may have the form of beads. In the case of using the thermoplastic acrylic resin in the particulate form, the conventional problem occurring in mixing 1 or more part by weight of the UV absorber with respect to 100 parts by weight of the acrylic resin may be solved, and 5 parts by weight of the UV absorber may be mixed with respect to 100 parts by weight of the acrylic resin by using only the solid-solid mixing. Since a significantly greater amount of UV absorber is mixed in the resin composition as compared with the conventional case, an optical film formed of the resin composition according to the exemplary embodiment of the present disclosure may have an excellent UV protection effect.

In addition, the average particle diameter of the particulate thermoplastic acrylic resin may be 10 μm to 500 μm, 50 μm to 400 μm, or 100 μm to 350 μm. In the case in which the average particle diameter of the thermoplastic resin particles is within the above range, when the UV absorber is mixed therewith through solid-solid mixing, a phenomenon in which the resin particles and the UV absorber form a bulk inside a mixing tank to block pipes may be prevented, and miscibility during extruding after the solid-solid mixing may be enhanced.

Meanwhile, the particulate thermoplastic acrylic resin may include a copolymer having (a) an alkyl(meth)acrylate-based unit and (b) a styrene-based unit. In addition, the particulate thermoplastic acrylic resin may further include an aromatic resin having a carbonate moiety in a main chain thereof.

According to the exemplary embodiment of the present disclosure, the alkyl(meth)acrylate-based unit may provide weak negative in-plane retardation (Rᵢₙ) and weak negative thickness-direction retardation (Rₜₕ) to the film during a stretching process, while the styrene-based unit may provide strong negative in-plane retardation (Rᵢₙ) and negative thickness-direction retardation (Rₜₕ) to the film. Meanwhile, the aromatic resin having the carbonate moiety in the main chain thereof may provide positive in-plane retardation (Rᵢₙ) and positive thickness-direction retardation (Rₜₕ).

Here, the negative in-plane retardation refers to the highest in-plane refractive index in a direction perpendicular to the stretching direction, while the positive in-plane retardation refers to the highest refractive index in the stretching direction. The negative thickness-direction retardation means that a thickness-direction refractive index is greater than an average in-plane refractive index, while the positive thickness-direction retardation means that the average in-plane refractive index is greater than the thickness-direction refractive index.

Due to the aforementioned properties of respective units, the retardation properties of the optical film manufactured using the same may change depending on the composition, stretching direction, stretching ratio and stretching method of respective components. By adjusting the composition and the stretching method of respective components in the exemplary embodiment of the present disclosure, a multilayer optical film that may be usable as a zero retardation film, i.e., a protective film, may be manufactured.

Meanwhile, the copolymer described in the present specification means that elements defined as “units” are polymerized into monomers such that the monomers as repeating units are included in the copolymer resin. The copolymer described in the present specification may be a block copolymer or a random copolymer, but types thereof are not limited thereto.

In addition, the alkyl(meth)acrylate-based unit in the present specification includes both an alkyl acrylate-based unit and an alkyl methacrylate-based unit. Considering optical transparency, compatibility, processability, and productivity, an alkyl moiety of the alkyl(meth)acrylate-based unit may have 1 to 10 carbon atoms, preferably 1 to 4 carbon atoms, and may be a methyl group or an ethyl group. More specifically, the alkyl(meth)acrylate-based unit may be at least one selected from the group consisting of methyl methacrylate, ethyl methacrylate, isopropyl methacrylate, n-butyl methacrylate, t-butyl methacrylate, hydroxyethyl methacrylate, isobonyl methacrylate and cyclohexyl methacrylate, but is not limited thereto.

Here, 70 to 98 parts by weight of, preferably 82 to 97 parts by weight of the alkyl(meth)acrylate-based unit may be included, based on 100 parts by weight of the copolymer. In the case in which the content of the alkyl(meth)acrylate-based unit is within the above range, an optical film having superior transmittance and heat resistance properties may be obtained, and double refraction occurring at the time of stretching the optical film may be minimized.

In addition, according to the exemplary embodiment of the present disclosure, (b) the styrene-based unit may improve polymerization efficiency between the monomers, and in the case of a film formed of the resin composition including the same, it may be easy to control the retardation of the film during the stretching process, whereby a zero retardation film having superior double refraction properties may be obtained.

Here, (b) the styrene-based unit may be a non-substituted styrene monomer or a substituted styrene monomer. The substituted styrene monomer may be styrene in which a benzene ring or a vinyl group is substituted with a substituent including aliphatic hydrocarbons or hetero atoms. For example, the styrene-based unit may be at least one selected from the group consisting of styrene, α-methylstyrene, 3-methylstyrene, 4-methylstyrene, 2,4-dimethylstyrene, 2,5-dimethylstyrene, 2-methyl-4-chlorostyrene, 2,4,6-trimethylstyrene, cis-β-methylstyrene, trans-β-methylstyrene, 4-methyl-α-methylstyrene, 4-fluoro-α-methylstyrene, 4-chloro-α-methylstyrene, 4-bromo-α-methylstyrene, 4-t-butylstyrene, 2-fluorostyrene, 3-fluorostyrene, 4-fluorostyrene, 2,4-difluorostyrene, 2,3,4,5,6-pentafluorostyrene, 2-chlorostyrene, 3-chlorostyrene, 4-chlorostyrene, 2,4-dichlorostyrene, 2,6-dichlorostyrene, octachlorostyrene, 2-bromostyrene, 3-bromostyrene, 4-bromostyrene, 2,4-dibromostyrene, α-bromostyrene and β-bromostyrene, but is not limited thereto. More preferably, styrene substituted with a C₁₋₄ alkyl or halogen group may be used. More specifically, the styrene-based monomer may be at least one selected from the group consisting of styrene, α-methylstyrene, p-bromostyrene, p-methylstyrene and p-chlorostyrene, preferably the group consisting of styrene, α-methylstyrene and p-methylstyrene.

Here, 0.1 to 10 parts by weight of, preferably 0.5 to 5 parts by weight of the styrene-based unit may be included, based on 100 parts by weight of the copolymer. In the case in which the content of the styrene-based unit is within the above range, it may be easy to control the retardation of the film during the stretching process, whereby the film may have a good effect in terms of optical properties.

Meanwhile, according to the exemplary embodiment of the present disclosure, the aromatic resin having the carbonate moiety in the main chain thereof may include 5 to 10,000 units, of which at least one species is expressed by chemical formula I below.

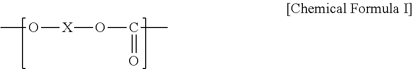

In chemical formula I, X is a bivalent group including at least one benzene ring. More specifically, X may preferably be a bivalent group selected from the group consisting of the following structural formulas:

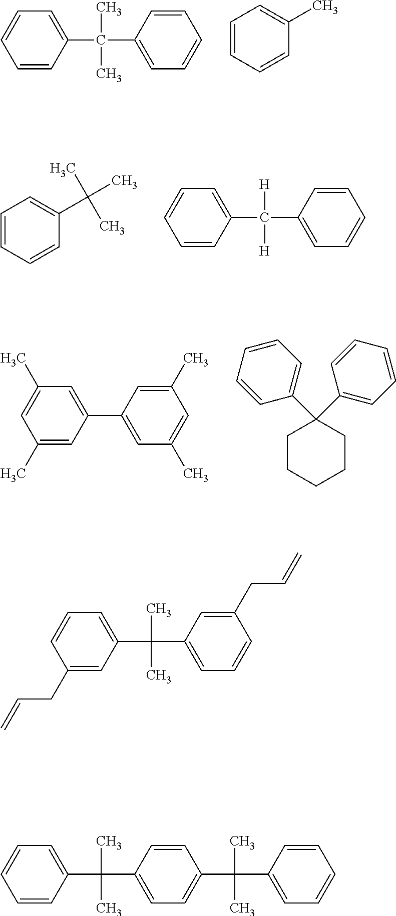

Meanwhile, 0.1 to 10 parts by weight of, preferably, to 5 parts by weight of the aromatic resin having the carbonate moiety in the main chain thereof which is added to control the retardation may be included, based on 100 parts by weight of the thermoplastic acrylic resin composition. In the case in which the content of the aromatic resin having the carbonate moiety in the main chain thereof is less than the above range, the thickness-direction retardation of the stretched film may be increased in a positive direction. In the case in which the content of the aromatic resin having the carbonate moiety in the main chain thereof exceeds the above range, the thickness-direction retardation of the stretched film may be increased in a negative direction. Furthermore, in the case in which the aromatic resin exceeds 10 parts by weight, compatibility with the thermoplastic acrylic resin composition may be lowered, resulting in a whitening phenomenon. Therefore, in the case in which the content of the aromatic resin having the carbonate moiety in the main chain thereof is within the above range, it may be controlled to allow an absolute value of the in-plane retardation (Rᵢₙ) represented by Equation 1 below and an absolute value of the thickness-direction retardation (Rₜₕ) represented by Equation 2 below to be 5 nm or less, preferably 3 nm or less, more preferably 0.

Rᵢₙ=(nₓ−n_{y})×d Equation 1

Rₜₕ=(n_{z}−n_{y})×d Equation 2

In Equation 1 and Equation 2, nₓ is the highest in-plane refractive index of the optical film; n_{y} is an in-plane refractive index of the optical film in a direction perpendicular to nₓ; n_{z} is a thickness-direction refractive index; and d is a thickness of the film.

Here, the resin composition according to the exemplary embodiment of the present disclosure including the copolymer resin and the aromatic resin having the carbonate moiety in the main chain thereof may be prepared by, for example, using a method known in the art such as a compounding method.

Furthermore, considering the fact that the copolymer including (a) the alkyl(meth)acrylate-based unit and (b) the styrene-based unit is capable of providing the film manufactured using the same with superior heat resistance properties, the copolymer may further include (c) a 3 to 6-element heterocyclic unit substituted with at least one carbonyl group, wherein the heterocyclic unit may be selected from the group consisting of maleic anhydride, maleimide, glutaric anhydride, glutarimide, lactones, and lactams. In addition, in the case in which (c) the 3 to 6-element heterocyclic unit and (a) the alkyl(meth)acrylate-based unit constitute the copolymer, compatibility of the copolymer resin and the aromatic resin having the carbonate moiety in the main chain thereof may be improved.

Meanwhile, (c) the 3 to 6-element heterocyclic unit substituted with at least one carbonyl group may be, for example, maleimide derivatives such as ethylmaleimide, n-butyl maleimide, t-butyl maleimide, cyclohexyl maleimide, phenylmaleimide and the like. In particular, a phenylmaleimide unit may be preferably used therefor. The phenylmaleimide unit may have a uniform chemical structure due to a phenyl group being substituted, thereby facilitating the forming of the copolymer together with (a) the alkyl(meth)acrylate-based unit and (b) the styrene-based unit, improving heat resistance, and requiring a relatively short polymerization time.

Meanwhile, the phenylmaleimide unit may be at least one selected from the group consisting of phenylmaleimide, nitrophenyl maleimide, monochlorophenyl maleimide, dichlorophenyl maleimide, monomethyl phenylmaleimide, dimethyl phenyl maleimide, and ethylmethylphenyl maleimide.

Here, 0.1 to 10 parts by weight of (c) the 3 to 6-element heterocyclic unit substituted with at least one carbonyl group may be included, based on 100 parts by weight of the copolymer resin. In the case in which the content of the 3 to 6-element heterocyclic unit substituted with at least one carbonyl group is within the above range, the optical film may have superior heat resistance properties, and may be prevented from being brittle due to unstable resin properties.

Meanwhile, according to the exemplary embodiment of the present disclosure, the thermoplastic acrylic copolymer may further include an alkyl acrylate-based unit so as to provide polymerization stability and thermal stability to the resin composition and to provide rigidity to the stretched film. The use of the alkyl acrylate-based unit may allow for the composition to have improved moldability in terms of releasability and the like, and have superior heat resistance properties by preventing a weight reduction caused by heat during the preparation process.

Here, an alkyl moiety of the alkyl acrylate-based monomer may be a cycloalkyl group or a substituted alkyl group, may have 1 to 10 carbon atoms, preferably 1 to 6 carbon atoms, and may be a methyl group or an ethyl group. Specifically, it may be methyl acrylate, ethyl acrylate, isopropyl acrylate, n-butyl acrylate, t-butyl acrylate, cyclohexyl acrylate, isobonyl acrylate, hydroxymethyl acrylate, or hydroxyethyl acrylate, but is not limited thereto.

Here, 0.1 to 5 parts by weight of, preferably 0.5 to 3.0 parts by weight of the alkyl acrylate-based unit may be included, based on 100 parts by weight of the particulate thermoplastic acrylic copolymer. In the case in which the content of the alkyl acrylate-based unit is within the above range, there are significantly advantageous effects of facilitating polymerization between (a) the alkyl(meth)acrylate-based unit and (c) the 3 to 6-element heterocyclic unit substituted with at least one carbonyl group in the forming of the copolymer, overcoming thermal decomposition that may occur during a resin melting process, and facilitating the stretching process by providing rigidity to the film during the stretching process of the film.

Meanwhile, the particulate thermoplastic acrylic resin used in the exemplary embodiment of the present disclosure may have a glass transition temperature of 110° C. or higher. For example, the glass transition temperature may be 115° C. or higher, 120° C. or higher, or 125° C. or higher. As the glass transition temperature of the particulate thermoplastic acrylic resin is increased, a fusion temperature at the time of preparing raw material pellets for an optical film is increased. Since the pellets can be prepared at relatively high temperatures, the resultant raw material pellets may have relatively low water content.

Then, the form of the UV absorber is not particularly limited. For example, the UV absorber may have the form of powder, granules or flakes, liquid, or the like.

In addition, 0.01 to 5 parts by weight of, preferably 0.1 to 4 parts by weight of the UV absorber may be included, based on 100 parts by weight of the particulate thermoplastic acrylic resin. In the case in which the content of the UV absorber exceeds 5 parts by weight, the lubrication action of the UV absorber at the time of preparing the pellets may lower the melting characteristics of the particulate thermoplastic acrylic resin, causing the mixing problem. In addition, in the case in which the content of the UV absorber is excessively high, the glass transition temperature (Tg) of the resin composition may be significantly lowered. In the case of forming the film using this resin composition, the heat resistance of the film may significantly decrease. Furthermore, in the case in which the content of the UV absorber is less than 0.01 part by weight, UV absorption performance may deteriorate, resulting in a failure to protect a polarizing element from UV light. That is, in the case in which the content of the UV absorber is within the above range, the melting characteristics of the particulate thermoplastic acrylic resin may be so excellent that it is easy to achieve stable miscibility during preparing the resin pellets, and superior UV absorption performance may be obtained while a decrease in the glass transition temperature may be reduced. Therefore, in the case of using the resin composition according to the exemplary embodiment of the present disclosure, it is easy to manufacture an optical film having a good UV protection effect in addition to superior heat resistance properties.

Meanwhile, the UV absorber is not particularly limited so long as the UV absorber has the maximum absorption wavelength (Amax) in a wavelength range of 280 nm to 380 nm. For example, the UV absorber may be a triazine-based UV absorber, preferably, a benzotriazine UV absorber including at least one hydroxyl group, aliphatics, and aliphatic ether.

Meanwhile, according to the exemplary embodiment of the present disclosure, the triazine-based UV absorber may have a molecular weight of 300 to 2000, 500 to 1900, or 400 to 1800. In the case in which the molecular weight of the UV absorber is within the above range, the thermal and mechanical characteristics of the particulate thermoplastic acrylic resin forming a comonomer with the UV absorber may be so excellent that the UV absorber is not extracted outwardly during film processing.

In addition, the glass transition temperature of the resin composition including the aforementioned components according to the exemplary embodiment of the present disclosure may be, for example, 120° C. to 500° C., preferably 125° C. to 500° C., more preferably 125° C. to 200° C. As the glass transition temperature of the resin composition is increased, a fusion temperature at the time of preparing the raw material pellets for the optical film is increased. Since the pellets can be manufactured at relatively high temperatures, the resultant raw material pellets may have a relatively low water content.

Here, considering processability, heat resistance and productivity, the resin composition according to the exemplary embodiment of the present disclosure may have a weight average molecular weight of 50,000 to 500,000, or 50,000 to 200,000. In the case in which the weight average molecular weight of the resin composition is less than 50,000, the brittleness of the film may be significantly increased, causing a failure to stretch the film. In the case in which the weight average molecular weight of the resin composition exceeds 200,000, melt viscosity may be significantly increased, causing a failure to extrude the film.

In addition, the resin composition according to the exemplary embodiment of the present disclosure may have a transparency (haze) of 0.1% to 3%, and a light transmittance of 90% or higher. Furthermore, the resin composition may have a yellow index of 0.3 to 2.0. In the case in which the transparency, the light transmittance and the yellow index of the resin composition are within the above range, a display device having superior color clarity may be obtained.

As described above, the resin composition according to the first exemplary embodiment of the present disclosure may have superior heat resistance properties and have a good UV absorption effect due to the inclusion of the UV absorber, and thus, it may be advantageously used for the optical film.

According to a second exemplary embodiment of the present disclosure, there is provided a method of preparing a resin composition, including: preparing a particulate thermoplastic acrylic resin; and mixing the acrylic resin and a UV absorber, wherein the mixing process is performed using a mixer having a gear pump. By performing the mixing process using the mixer having the gear pump, uniformity in the size of raw material pellets prepared using the resin composition according to the exemplary embodiment of the present disclosure may be advantageously secured.

Meanwhile, in the method of preparing a resin composition according to the exemplary embodiment of the present disclosure, the acrylic resin may be prepared through solution polymerization, bulk polymerization, suspension polymerization, or emulsion polymerization. In particular, in the method of preparing a resin composition according to the exemplary embodiment of the present disclosure, considering facilitation of preparing the resin composition having a particle size of 10 μm to 500 μm, 50 μm to 400 μm, or 100 μm to 350 μm, suspension polymerization or emulsion polymerization may be performed. Among the aforementioned polymerization methods, in the case of solution polymerization and bulk polymerization, degeneration of the UV absorber may occur due to a relatively high polymerization temperature during the polymerization process, and in the case of emulsion polymerization, it may be difficult to satisfy the above particle size range, and it may be necessary to additionally remove a used emulsifier.

Next, an additive having UV absorption performance may be mixed with the particulate acrylic resin prepared using the aforementioned method. Here, the mixing process may be performed through solid-solid mixing. The solid-solid mixing process may be appropriate for forming a thermoplastic resin having UV absorption performance since it has various advantages in adjusting the content of the UV absorber with ease and using various types of UV absorber.

Meanwhile, the mixing process may be performed by the mixer. Here, the mixer may be, for example, a single screw extruder, a twin screw extruder, or the like. In particular, a twin screw extruder manufactured by Leistritz may be used as the mixer. However, the mixer is not limited thereto.

In addition, a ratio of a mixing part in the extruder may be 0.15 to 0.5, or 0.2 to 0.4, wherein the ratio of the mixing part refers to a ratio of the length of a kneading block to the overall length of the screw. In the case in which the ratio of the mixing part is less than 0.15, insufficient miscibility and melting properties may cause the resin to be extruded in a non-melted or non-mixed state. In the case in which the ratio of the mixing part exceeds 0.4, excessive miscibility and melting properties may cause decomposition of the resin.

Meanwhile, the mixing process may be performed by using the mixer having the gear pump in order to secure uniformity in the size of the raw material pellets prepared using the resin composition. In the case in which the uniformity in the size of the pellets is secured, pressure instability resulting from non-uniform resin discharge may be prevented during melting processing, and thus, thickness variation of a film and defects in the exterior appearance of the film may be prevented. That is, the aforementioned problems, i.e., the film thickness variation and the appearance defect, may be resolved by using the mixer having the gear pump capable of supplying the resin at uniform pressure, and the resin pellets prepared using the aforementioned method may have a uniform size.

In addition, the mixing process may be performed by a mixer having a polymer filter. Here, the polymer filter may have pores of 50 μm or less. In the case of using the mixer having the polymer filter, it may be advantageous in decreasing the number of black spots in the resin composition to thereby remove impurities. Here, the polymer filter may be a leaf disk type filter, a candle type filter, or the like, and it may be combined with a back filter. However, the polymer filter is not limited thereto. Meanwhile, in the case in which the size of the pores in the polymer filter is 50 μm or less, impurity removal performance may be excellent, and thus, products may be manufactured to have good exterior appearance.

A difference between the maximum and minimum diameters of the resin pellets prepared using the aforementioned method according to the exemplary embodiment of the present disclosure may be 5 mm or less, 3 mm or less, or 2 mm or less. In the case in which the difference between the maximum and minimum diameters of the pellets is within the above range, pressure instability resulting from non-uniform resin discharge may be prevented during the melting processing of the pellets, and thus, thickness variation of a film and defects in the exterior appearance of the film may be prevented.

In addition, the number of black spots in the resin pellets may be 0/100 g to 10/100 g, 0/100 g to 8/100 g, or 0/100 g to 5/100 g. In the case in which the number of black spots is within the above range, the generation of the impurities is reduced, and consequently, an optical film having good exterior appearance may be obtained.

As described above, in the method of preparing a resin composition according to the second exemplary embodiment of the present disclosure, the uniformity in the size of the resin pellets prepared using the resin composition may be secured and the impurity generation rate may be significantly lowered, whereby the preparation method may be advantageously used to manufacture an optical film having superior thickness uniformity and good exterior appearance.

Then, according to a third exemplary embodiment of the present disclosure, there is provided an optical film manufactured by using resin pellets formed of a resin composition including a particulate thermoplastic acrylic resin and a triazine-based UV absorber.

Here, the resin composition may be formed as the optical film by using a method known in the art such as a solution casting method or an extruding method. Considering the economical aspect, the extruding method may be preferably used. In some cases, an additive such as a conditioner may be added without harming the properties of the film during the film manufacturing process, and uniaxial or biaxial stretching may be additionally carried out.

The stretching process may be performed in a machine direction (MD direction), in a transverse direction (TD direction), or in both MD and TD directions. In the case in which the stretching process is performed in the MD and TD directions, it may be performed in one direction and be then performed in the other direction, or it may be performed in both directions at the same time. Meanwhile, the stretching process may be performed in a single step or in multiple steps. In the case of the stretching process in the MD direction, the stretching process may be carried out by a difference in the stretching rates of rolls. In the case of the stretching process in the TD direction, a tenter may be used. By adjusting inclination angles of tenter rails to be within 10°, a bowing phenomenon that may occur at the time of stretching in the TD direction may be suppressed and an angle of an optical axis may be regularly controlled. In the case in which the TD directional stretching process is performed in multiple steps, the effect of suppressing the bowing phenomenon may be obtained.

Meanwhile, the stretching process may be performed at a temperature of (Tg−20° C.) to (Tg+30° C.), where Tg denotes the glass transition temperature of the resin composition. The above temperature range may be from a temperature at which a storage modulus starts to decrease and accordingly a loss modulus is higher than the storage modulus, to a temperature at which the orientation of a polymer chain is alleviated and loss of the polymer chain is completed. The glass transition temperature of the resin composition may be measured by a differential scanning calorimeter (DSC). The stretching temperature may be equal to the glass transition temperature of the resin composition.

The stretching operation may be carried out at a stretching rate of 1 m/min to 100 m/min in the case of a small stretching machine (a universal testing machine, Zwick 2010) and at a stretching rate of 0.1 m/min to 2 m/min in the case of pilot stretching equipment, and a stretching magnification may be 20% to 300%. Here, the stretching magnification refers to a magnification of a stretched portion of the film. For example, in a case in which the stretching magnification is 50%, the stretching of the film is carried out 1.5 times.

The retardation properties of the film may be adjusted through the above-described stretching process.

In the case of the optical film manufactured using the aforementioned method according to the exemplary embodiment of the present disclosure, the straight light transmittance thereof may be 85% to 98% or 90% to 95% in a wavelength range of 400 nm to 800 nm when being measured by converting the thickness of the film to 60 μm. In the case in which the straight light transmittance is within the above range in the wavelength range of 400 nm to 800 nm, the transmittance of a polarizing plate may be improved. In the present specification, the straight light transmittance refers to a transmittance obtained by subtracting scattered light transmittance from the total light transmittance.

In addition, in the case of the optical film manufactured using the aforementioned method according to the exemplary embodiment of the present disclosure, the straight light transmittance thereof may be 1% to 15% or 1% to 10% in a wavelength of 380 nm when being measured by converting the thickness of the film to 60 μm. In the case in which the straight light transmittance is within the above range in the wavelength of 380 nm, the degeneration of polarizer caused by UV light may be prevented. The transmittance may also be improved in a visible light wavelength of 400 nm, and discoloration of the polarizing plate may be prevented.

Furthermore, in the case of the optical film according to the exemplary embodiment of the present disclosure, the straight light transmittance thereof may be 0.01% to 5% or 0.02% to 3% in a wavelength of 290 nm when being measured by converting the thickness of the film to 60 μm. In the case in which the straight light transmittance is within the above range in the wavelength of 290 nm, the degeneration of polarizer caused by strong UV energy may be prevented, and the yellowing rate of the film may be decreased.

The optical film according to the exemplary embodiment of the present disclosure may have a good UV absorption effect since it includes an additive having UV absorption performance, while having superior heat resistance properties, and may have high light transmittance in the visible light region, and thus, it may be usefully used as a protective film.

### MODE FOR DISCLOSURE

### Inventive Example 1

### (1) Preparation of Resin Composition

A monomer mixture of 1000 g including 92 parts by weight of methyl methacrylate, 5 parts by weight of N-phenyl maleimide, 2 parts by weight of α-methyl styrene and 1 part by weight of methacrylate was prepared and mixed with distilled water of 2000 g, a 5% polyvinyl alcohol solution of 8.4 g (POVAL PVA217, Kuraray), boric acid of 0.1 g, normal octyl mercaptan of 2.5 g and 2,2′-azobis isobutyronitrile of 1.5 g in a 5 L reactor, to be dispersed in water while being stirred at 400 rpm.

Next, primary polymerization was performed at 80° C., and a suspension reached 80° C., and then, it was confirmed that a polymerization peak was observed after about 60 minutes. Then, the temperature was increased to 115° C., and secondary polymerization was carried out for about 40 minutes. After the secondary polymerization, the suspension was cooled to 30° C., and the polymerized resin composition having a particulate form was obtained. The resin composition was cleaned with distilled water, dehydrated and dried.

Here, as a result of observing the resin composition using an optical microscope (LV100P, Nikon), the resin composition had the form of beads having an average particle diameter of 250 μm.

### (2) Preparation of Raw Material Pellets

Next, 1 part by weight of a triazine-based UV absorber (LA-F70, ADEKA) was added to 100 parts by weight of the resin composition, and they were mixed in a solid mixer for two minutes, and then, agglomeration of the mixture was observed with the naked eye. Thereafter, the raw material mixture obtained as described above was supplied from a raw-material hopper to a 24φ extruder substituted with nitrogen, and was melted at 260° C. During this process, the melt extrusion properties of the resin were observed with the naked eye.

Then, the melted resin was supplied to a gear pump at a pressure of 50 bars, was supplied to a polymer filter having pores of 10 μm at a pressure of 60 bars, and was discharged from a die at a pressure of 30 bars, thereby forming raw material pellets.

A glass transition temperature (Tg) of the prepared resin was measured using a differential scanning calorimeter (DSC823, Mettler Toledo) at an increasing heating rate of 10° C./min. In addition, black spots of the prepared raw material pellets were observed using a pellet inspection system (Pellet Inspection PS25C, OCS).

### (3) Manufacturing of Optical Film

The raw material pellets were hot-air dried at 80° C. for 6 hours, and were melted at 260° C. using an extruder. The resultant pellets were allowed to pass through a coat hanger type T-die, a chrome plated casting roll, a dry roll, and the like, thereby manufacturing an optical film having a thickness of 210 μm.

The film was stretched 100% in MD and TD directions, at a rate of 200 mm/min, at 131° C. to 135° C. higher than the glass transition temperature (Tg) of each film by 10° C., using experimental film stretching equipment, thereby manufacturing an optical film having a thickness of 55 μm.

### Inventive Example 2

A resin composition, raw material pellets and an optical film were prepared using the same method as that of inventive example 1, with the exception of using 1 part by weight of NST5 (DKSH, Switzerland) as the triazine-based UV absorber.

### Comparative Example 1

A resin composition was prepared using the same method as that of inventive example 1, with the exception of adding a polyvinyl alcohol solution of 12.0 g and 2,2′-azobis isobutyronitrile of 3.0 g thereto.

Here, as a result of observing the resin composition using the optical microscope (LV100P, Nikon), the resin composition had the form of beads having an average particle diameter of 5 μm.

Then, the resin composition was used to prepare raw material pellets using the same method as that of inventive example 1. However, the preparation of the raw material pellets was not smoothly performed due to the agglomeration between the resin particles in the form of beads and the UV absorber after solid mixing.

### Comparative Example 2

A resin composition was prepared using the same method as that of inventive example 1, with the exception of adding a polyvinyl alcohol solution of 6.0 g and 2,2′-azobis isobutyronitrile of 0.8 g thereto.

Here, as a result of observing the resin composition using the optical microscope (LV100P, Nikon), the resin composition had the form of beads having an average particle diameter of 550 μm.

Then, the resin composition was used to prepare raw material pellets using the same method as that of inventive example 1. During this process, the agglomeration between the resin particles in the form of beads and the UV absorber after solid mixing did not occur, but it was not easy to melt the large particles, whereby extrudability was lowered. Thus, the preparation of the raw material pellets was not smoothly performed.

### Comparative Example 3

After a resin composition was prepared using the same composition and the same method as those of inventive example 1, raw material pellets were prepared using the resin composition in the same method as that of inventive example 1, without including the UV absorber.

Then, an optical film was manufactured to have a thickness of 54 μm by using the raw material pellets in the same method as that of inventive example 1.

### Comparative Example 4

After a resin composition was prepared using the same composition and the same method as those of inventive example 1, raw material pellets were prepared using the same method as that of inventive example 1, with the exception of including 6 parts by weight of the UV absorber based on 100 parts by weight of the resin composition.

Then, an optical film was manufactured to have a thickness of 57 μm by using the raw material pellets in the same method as that of inventive example 1.

### Comparative Example 5

After a resin composition was prepared using the same composition and the same method as those of inventive example 1, raw material pellets were prepared using the resin composition in the same method as that of inventive example 1, with the exception of performing mixing by using a mixer from which the gear pump was removed.

Then, an optical film was manufactured to have a thickness of 55 μm by using the raw material pellets in the same method as that of inventive example 1.

### Comparative Example 6

After a resin composition was prepared using the same composition and the same method as those of inventive example 1, raw material pellets were prepared using the same method as that of inventive example 1, with the exception of performing mixing by using a mixer including a polymer filter having a pore size of 100 μm.

Then, an optical film was manufactured to have a thickness of 52 μm by using the raw material pellets in the same method as that of inventive example 1.

### Comparative Example 7

After a resin composition was prepared using the same composition and the same method as those of inventive example 1, raw material pellets were prepared using the same method as that of inventive example 1, with the exception of adding a triazole-based UV absorber (TINUVIN 326, BASF) to the resin composition.

Then, an optical film was manufactured to have a thickness of 59 μm by using the raw material pellets in the same method as that of inventive example 1.

### Comparative Example 8

A resin composition was prepared using the same method as that of inventive example 1, with the exception of using a monomer mixture including 10 parts by weight of anhydric maleic acid, 23 parts by weight of a styrene monomer, and 67 parts by weight of methyl methacrylate.

However, in the preparation of the resin composition, the anhydric maleic acid having a significantly high solubility with respect to water was diffused from the monomer mixture into distilled water during the polymerization process, thereby preventing the resin composition from being normally formed as particles. The resin composition was agglomerated in a reactor, causing a failure to prepare raw material pellets and an optical film.

### Comparative Example 9

A monomer mixture including 92 parts by weight of methyl methacrylate, 5 parts by weight of N-phenyl maleimide, 2 parts by weight of α-methyl styrene and 1 part by weight of methacrylate was mixed with a toluene solvent in a weight ratio of 80:20 (monomer mixture:toluene), and a polymerization solution was prepared by introducing 0.03 parts by weight of dicumyl peroxide (DCP) as a polymerization initiator and 0.5 parts by weight of t-dodecyl mercaptan (TDDM) as a molecular weight modifier into the mixed solution. Thereafter, the polymerization solution was introduced into a 16 L reactor at a rate of 12 L/hr and was polymerized through continuous bulk polymerization at a reaction temperature of 155° C.

Then, the polymerization solution was transferred to the reactor at a polymerization conversion rate of less than 50%, and was transferred to a devolatilization tank of 20 Torr and 250° C. when the polymerization conversion rate reached 80%. The unreacted monomer and the solvent were removed from the devolatilization tank, and the resin composition having a particle diameter of 3 mm to 5 mm was prepared.

The resin composition was used to prepare raw material pellets including the UV absorber by using the same method as that of inventive example 1. However, in the mixing process of the resin composition having such a large diameter and the UV absorber, the lubrication action of the UV absorber led to a failure to melt the raw material pellets, and thus, it was observed that the resin composition having a particle diameter of 3 mm to 5 mm itself was discharged to a vent of an extruder.

Evaluation results of the properties of the resin compositions prepared according to inventive example 1 and comparative examples 1 to 9 are shown in Table 1 and Table 2 below.

TABLE 1

| | Form of | Average Particle | | Content | |
|---|---|---|---|---|---|
| | Particles of | Diameter of | | of UV | Presence |
| | Resin | Resin | UV | Absorber | of Gear |
| | Composition | Composition (μm) | Absorber | (wt %) | Pump |
| Inventive | Beads | 250 | Triazine- | 1 | Presence |
| Example 1 | | | based | | |
| Inventive | Beads | 250 | Triazine- | 1 | Presence |
| Example 2 | | | based | | |
| Comparative | Beads | 5 | Triazine- | 1 | Presence |
| Example 1 | | | based | | |
| Comparative | Ellipses | 550 | Triazine- | 1 | Presence |
| Example 2 | | | based | | |
| Comparative | Beads | 250 | — | — | Presence |
| Example 3 | | | | | |
| Comparative | Beads | 250 | Triazine- | 6 | Presence |
| Example 4 | | | based | | |
| Comparative | Beads | 250 | Triazine- | 1 | None |
| Example 5 | | | based | | |
| Comparative | Beads | 250 | Triazine- | 1 | Presence |
| Example 6 | | | based | | |
| Comparative | Beads | 250 | Triazole- | 1 | Presence |
| Example 7 | | | based | | |
| Comparative | Failure to Form | — | — | — | — |
| Example 8 | Particles | | | | |
| Comparative | Particles of | — | — | — | — |
| Example 9 | 3 mm-5 mm. | | | | |

TABLE 2

| | | | | | Number |
|---|---|---|---|---|---|
| | | | | | of |
| | | Melt | Pellet | | Black |
| | | Extrusion | Diameter | Tg | Spots |
| | Agglomeration | Properties | (mm) | (° C.) | (n/100 g) |
| Inventive | X | ◯ | 2-3 | 125 | 1 |
| Example 1 | | | | | |
| Inventive | X | ◯ | 2-3 | 125 | 1 |
| Example 2 | | | | | |
| Comparative | ◯ | ◯ | 2-3 | 125 | 0 |
| Example 1 | | | | | |
| Comparative | X | X | 2-3 | 125 | 1 |
| Example 2 | | | | | |
| Comparative | X | ◯ | 2-3 | 125 | 1 |
| Example 3 | | | | | |
| Comparative | X | ◯ | 2-3 | 122 | 2 |
| Example 4 | | | | | |
| Comparative | X | ◯ | 1-5 | 125 | 1 |
| Example 5 | | | | | |
| Comparative | X | ◯ | 2-3 | 125 | 30 |
| Example 6 | | | | | |
| Comparative | X | ◯ | 2-3 | 123 | 1 |
| Example 7 | | | | | |

### Experimental Example 1

### Contamination of Roll or Measuring Number of Black Spots

With respect to the optical films manufactured according to inventive examples 1 and 2 and comparative examples 1 to 7, the surface of the casting roll was observed with the naked eye in 1 hour after the film was formed, thereby determining the contamination thereof caused by the UV absorber. At the time of observing the surface of the casting roll with the naked eye, the degree of contamination of the casting roll was indicated as “x” in the case in which a haze portion was observed on the surface of the roll, and was indicated as “∘” in the case in which the surface of the roll was maintained to be as clean as a glass surface. In addition, the number of black spots per unit area was measured by magnifying the manufactured optical film 6 times using an overhead projector (OHP) (3M). The results are shown in Table 3 below.

### Experimental Example 2

### Measuring Straight Light Transmittance and Yellow Index

With respect to the optical films manufactured according to inventive examples 1 and 2 and comparative examples 1 to 7, the straight light transmittance of each optical film was measured in wavelengths of 380 nm and 290 nm by using a spectrophotometer (U-3310, Hitachi), the yellow index of each optical film was measured using a color difference meter (CM-508c, Minolta). The results are shown in Table 3 below.

TABLE 3

| | Film | | Number of | | | |
|---|---|---|---|---|---|---|
| | Thick- | Contam- | Black | Transmittance | | |
| | ness | ination | Spots | (%) | | Yellow |
| | (μm) | of Roll | (n/m²) | 380 nm | 290 nm | Index |
| Inven- | 55 | X | 0 | 1.21 | 4.43 | 2.9 |
| tive Ex- | | | | | | |
| ample 1 | | | | | | |
| Inven- | 55 | X | 0 | 1.26 | 4.17 | 3.2 |
| tive Ex- | | | | | | |
| ample 2 | | | | | | |
| Compar- | — | — | — | — | — | — |
| ative Ex- | | | | | | |
| ample 1 | | | | | | |
| Compar- | — | — | — | — | — | — |
| ative Ex- | | | | | | |
| ample 2 | | | | | | |
| Compar- | 54 | X | 1 | 92.1 | 90.8 | 1.1 |
| ative Ex- | | | | | | |
| ample 3 | | | | | | |
| Compar- | 57 | ◯ | 2 | 0 | 0 | 4.8 |
| ative Ex- | | | | | | |
| ample 4 | | | | | | |
| Compar- | 55 | X | 2 | 1.2 | 4.44 | 2.9 |
| ative Ex- | | | | | | |
| ample 5 | | | | | | |
| Compar- | 52 | X | 24 | 1.29 | 4.52 | 2.8 |
| ative Ex- | | | | | | |
| ample 6 | | | | | | |
| Compar- | 59 | ◯ | 1 | 18.7 | 8.81 | 1.4 |
| ative Ex- | | | | | | |
| ample 7 | | | | | | |

As shown in Table 2, the resin pellets prepared according to inventive examples 1 and 2 had no agglomeration of the particles and superior melt extrusion properties. However, in the case of comparative example 1, the resin particles were agglomerated with the UV absorber, resulting in a failure to smoothly prepare the resin pellets, and in the case of comparative example 2, the melt extrusion properties were lowered, resulting in a failure to smoothly prepare the resin pellets. In the case of comparative example 5, since the mixer used did not have the gear pump, the melted resin was not uniformly supplied to the die, resulting in non-uniformity in the size of the resin pellets. In the case of comparative example 6, a large number of black spots were observed. In the case of comparative example 8, the polymerization was not smoothly performed, resulting in a failure to prepare the particulate acrylic resin. In the case of comparative example 9, the particle diameter of the resin was too large to mix the resin with the UV absorber.

Meanwhile, as shown in Table 3, the optical films manufactured according to inventive examples 1 and 2 had good exterior appearance and superior UV protection performance. In addition, since the optical films manufactured according to inventive examples 1 and 2 had lower straight light transmittance in the wavelengths of 380 nm and 290 nm, as compared with that of the optical films manufactured according to the comparative examples, the degeneration of the polarizer or the discoloration of the polarizing plate caused by UV light may be prevented, and the yellow index may be lowered. However, the optical film manufactured according to comparative example 3 had significantly poor UV protection performance, and the optical films manufactured according to comparative examples 4, 6 and 7 had many problems such as the contamination of the roll or the large number of black spots.

While exemplary embodiments have been shown and described above, it will be apparent to those skilled in the art that modifications and variations could be made without departing from the scope of the present invention as defined by the appended claims.

1. A resin composition comprising:
a particulate thermoplastic acrylic resin; and
a triazine-based ultraviolet (UV) absorber.

2. The resin composition of claim 1, wherein the particulate thermoplastic acrylic resin has an average particle diameter of 10 μm to 500 μm.

3. The resin composition of claim 1, wherein the particulate thermoplastic acrylic resin includes a copolymer having an alkyl(meth)acrylate-based unit and a styrene-based unit.

4. The resin composition of claim 3, wherein the particulate thermoplastic acrylic resin further includes an aromatic resin having a carbonate moiety in a main chain thereof.

5. The resin composition of claim 1, wherein the particulate thermoplastic acrylic resin includes a copolymer having an alkyl(meth)acrylate-based unit, a styrene-based unit, and a 3 to 6-element heterocyclic unit substituted with at least one carbonyl group.

6. The resin composition of claim 1, wherein the particulate thermoplastic acrylic resin includes a copolymer having an alkyl(meth)acrylate-based unit, a styrene-based unit, a 3 to 6-element heterocyclic unit substituted with at least one carbonyl group, and an alkyl acrylate-based unit.

7. The resin composition of claim 1, wherein the triazine-based UV absorber is included in a content of 0.1 to 5 parts by weight, based on 100 parts by weight of the particulate thermoplastic acrylic resin.

8. The resin composition of claim 1, wherein the triazine-based UV absorber has a weight average molecular weight of 300 to 2000.

9. Resin pellets prepared by using the resin composition according to claim 1.

10. The resin pellets of claim 9, wherein the number of black spots is 0/100 g to 10/100 g.

11. The resin pellets of claim 9, wherein a difference between maximum and minimum diameters of the resin pellets is 5 mm or less.

12. A method of preparing a resin composition, the method comprising:
preparing a particulate thermoplastic acrylic resin; and
mixing the particulate acrylic resin with a triazine-based ultraviolet (UV) absorber,
wherein the mixing is performed using a mixer including a gear pump.

13. The method of claim 12, wherein the particulate acrylic resin has an average particle diameter of 10 μm to 500 μm.

14. The method of claim 12, wherein the preparing of the particulate thermoplastic acrylic resin is performed using suspension polymerization or emulsion polymerization.

15. The method of claim 12, wherein the mixing is performed using a mixer including a polymer filter having a pore size of 50 μm or less.

16. An optical film manufactured using the resin pellets according to claim 9.

17. The optical film of claim 16, wherein straight light transmittance thereof is 1% to 15% in a wavelength of 380 nm when being measured by converting a thickness of the optical film to 60 μm.

18. The optical film of claim 16, wherein straight light transmittance thereof is 0.01% to 5% in a wavelength of 290 nm when being measured by converting a thickness of the optical film to 60 μm.
